(19) United States
(12) Patent Application Publication
(10) Pub. No.: US 2004/0166978 A1
(43) Pub. Date: Aug. 26, 2004

(54) Silent chain and method of producing the same

(75) Inventors: Akio Matsuda, Nabari (JP); Naoji Sakamoto, Nabari (JP); Yasuaki Nishimori, Nabari (JP)

Correspondence Address: BORGWARNER INC., POWERTRAIN TECHNICAL CENTER, 3800 AUTOMATION AVENUE, SUITE 100, AUBURN HILLS, MI, 48326-1782, US

(73) Assignee: BorgWarner Morse TEC Japan K.K., Nabari (JP)

(21) Appl. No.: 10/651,155

(22) Filed: Aug. 28, 2003

(30) Foreign Application Priority Data
Oct. 24, 2002 (JP) 2002-309301

(51) Int. Cl. F16G 13/04

(52) U.S. Cl. 474/212; 474/213

(57) ABSTRACT

The present invention provides a silent chain that can decrease noise and improve oscillation performance. A silent chain 1 includes a plurality of link plates interlaced in a thickness and length direction and guide links 4, 4′ disposed on the outside edge portions of the link plates, where the link plates and the guide links are connected by connecting pins. The guide link 4 has a yield load lower than that of the guide link 4′. These guide links 4, 4′ are located at a random pattern along the length of the chain. During operation, at the onset of the engagement with a sprocket tooth, contact with an inside flank of a link plate varies aperiodically. When the engagement proceeds and an outside flank of the link plate seats on the sprocket, seating at the sprocket tooth varies aperiodically.

### REFERENCE TO RELATED APPLICATIONS

This application claims priority from Japanese Application No. 2002-309301, filed Oct. 24, 2002 under the benefit of 35 USC §119 (a)-(d) or §365(b). The aforementioned application is hereby incorporated by reference.

### BACKGROUND OF THE INVENTION

1. Field of the Invention

The invention pertains to the field of chains. More particularly, the invention pertains to a silent chain that improves noise and oscillation performance.

2. Description of Related Art

Silent chains have been used as a power transmission chains in automobiles, motorcycles or the like. A silent chain is generally comprised of a plurality of link plates each having a pair of pin apertures and teeth, arranged in lateral and longitudinal directions, and pivotably connected by connecting pins inserted in the pin apertures.

In a silent chain, noise is generated when the chain and the sprocket engage. To help decrease this noise random chains were developed. A random chain is comprised of two kinds of link plates such as shown in prior art FIGS. 9 and 10. Link plate 100 shown in FIG. 9 is a standard-type link plate, which has a pair of pin apertures 101 and a pair of teeth 102 each formed of an inside flank 103 and an outside flank 104.

Prior art FIG. 10 shows a random link. A random link 110 has a pin aperture 101 similar to that of prior art FIG. 9, but has a tooth 112 whose shape is different from the tooth 102 of FIG. 9. That is, tooth 112 is composed of an outside flank 104 similar to the outside flank 104 of the link plate 100 and an inside flank 113 formed of a convexly curved surface protruding more inwardly than the inside flank 103 of the link plate 100. In prior art FIG. 10, a dash-and-dot line indicates a contour of the inside flank 103 of the link plate 100. A random chain is constructed of a plurality of link rows or guide rows that have an arrangement of random links 110 and the remaining guide rows or link rows are formed of link plates 100.

During operation of the random chain, the engagement of the sprocket tooth with the inside flank of a link depends on whether the link rows or guide rows is comprised of a standard link 100 or a random link 110. By varying the link type, the inside flank of the links engage the sprocket at different times and thus periodic noise in prior art chains may be reduced.

However, the conventional random chain decreases noise at the time of initial engagement only. Therefore, a random chain of the prior art is not sufficient to reduce the noise in the middle of the engagement to the end of the engagement of the link plates with the sprocket.

Incidentally, pre-stressing has been generally conducted in recent silent chains after assembly of the silent chains. The pre-stress load is a tensile load, which is applied to the entire silent chain in such a way that a load greater than the yield load of the link plate forming the silent chain can be imparted to the link plate. By means of pre-stressing, a pitch of the link plate causes a plastic elongation to become a new pitch.

The present invention has been made in view of these circumstances and decreases noise from the initial engagement to the final engagement with a sprocket tooth, which improves noise and oscillation performance. The present invention is directed to advancing the noise and oscillation performance of a silent chain by utilizing such a pre-stress load.

### SUMMARY OF THE INVENTION

A silent chain according to a first aspect of the present invention is characterized in that at least two kinds of guide links whose yield loads differ from each other are randomly disposed along the length of the chain. The term “yield load” as used in the preceding and following description as well as in the claims refers to the tensile load at which plastic deformation begins to occur.

After pre-stressing operation, plastic elongation of a pitch of each guide link and thus, plastic elongation of a pitch of each link plate in the guide rows containing the guide links vary according to which guide link the guide row contains. That is, a guide plate that has a relatively small yield load causes a relatively greater plastic elongation of a pitch, thereby producing a greater plastic elongation of a pitch of a link plate in the guide row containing the guide plate. As a result, the engagement pitch of a link plate, i.e. the distance between the outside flanks (or the inside flanks) along the engaging pitch line, becomes greater.

In contrast, a guide plate that has a relatively great yield load causes a relatively smaller plastic elongation of a pitch, thereby producing a smaller plastic elongation of a pitch of a link plate in the guide row containing the guide plate. As a result, the engagement pitch of a link plate thus becomes smaller. The guide rows of different engagement pitches are disposed at a random pattern along the length of a chain.

Therefore, for example, in the case of a silent chain that initially engages at an inside flank and finally engages at an outside flank with a sprocket tooth, the engaging state of the inside flank of a link plate with a sprocket tooth at the onset of engagement varies aperiodically. When the engagement point is transferred from the inside flank to the outside flank and the outside flank seats on the sprocket tooth, the engaging state of the outside flank of a link plate with a sprocket tooth also varies aperiodically. Thereby, noise that occurs from the initial engagement to the final engagement can be reduced and noise and oscillation performance are improved.

The yield loads of the guide links differ from each other according to the difference of thickness, hardness, material or plane geometry of each guide link. When thickness, hardness or plane geometry of each guide link is made different, rigidity of each guide link also becomes different. In this case, during operation of a silent chain, as each guide link deforms elastically due to tension imparted to the chain, elastic deformation of each guide link becomes different. Guide links of different elastic deformations are thus disposed at a random pattern along the length of the chain. Thereby, in operation, engaging state at the time of initial engagement with a sprocket tooth and seating state at the time of seating on a sprocket tooth, i.e. final engagement, vary aperiodically. As a result, noise occurring from the initial engagement to the final engagement can be decreased and noise and oscillation performance can be advanced.

Each guide link may be composed of a plurality of laminated thin plates. The thickness of each guide link is made different according to the difference of the number of the laminated thin plates. The yield load of each guide link may be lower than that of each link plate. In this case, guide links of more than two kinds of thicknesses may be constructed from a thin plate of a given thickness. Thereby, a single kind of press die for blanking a guide link is needed, and thus, manufacturing cost can be lessened. Plane geometry of each guide link varies from each other according to with/without a crotch, the difference of the depth of a crotch, with/without an opening, or the difference of the size of an opening formed in the guide link.

A silent chain according to a second aspect of the present invention is characterized in that at least two kinds of link plates whose yield loads differ from each other, are randomly disposed along the length of the chain.

After pre-stressing operation, plastic elongation of a pitch of each link plate and thus, plastic elongation of a pitch of each link row containing the link plates varies according to which link plate the link row contains. That is, a link plate that has a relatively small yield load causes a relatively greater plastic elongation of a pitch, thereby producing a greater plastic elongation of a pitch of a link row containing the link plate. As a result, the engagement pitch of the link plate in the link row becomes greater.

In contrast, a link plate that has a relatively great yield load causes a relatively smaller plastic elongation of a pitch, thereby producing a smaller plastic elongation of a pitch of a link row containing the link plate. As a result, the engagement pitch of the link plate becomes smaller. Link rows of different engagement pitches are disposed at a random pattern along the length of a chain.

Therefore, as with the first aspect of the present invention, in the case of a silent chain that initially engages at an inside flank and finally engages at an outside flank with a sprocket tooth, the engaging state of the inside flank of a link plate with a sprocket tooth at the onset of the engagement varies aperiodically. When the engaging point is transferred from the inside flank to the outside flank and the outside flank seats on the sprocket tooth, the engaging state of the outside flank of a link plate with a sprocket tooth also varies aperiodically. Thereby, noise that occurs from the initial engagement to the final engagement can be reduced and noise and oscillation performance are improved.

When thickness, hardness or plane geometry of each link plate is made different, rigidity of each link plate also becomes different. In this case, during operation of a silent chain, as each link plate deforms elastically due to tension imparted to the chain, elastic deformation of each link plate becomes different. Link plates of different elastic deformations are thus disposed at a random pattern along the length of the chain. Thereby, in operation, engaging state at the time of initial engagement with a sprocket tooth and seating state at the time of seating on a sprocket tooth, i.e. final engagement, vary aperiodically. As a result, noise occurring from the initial engagement to the final engagement can be decreased and noise and oscillation performance can be advanced.

Each link plate may be composed of a plurality of laminated thin plates. The thickness of each link plate is made different according to the difference of the number of the laminated thin plates. In this case, link plates of more than two kinds of thicknesses can be constructed from a thin plate of a given thickness. Thereby, a single kind of press die for blanking a link plate is needed, and thus, manufacturing cost can be lessened. Likewise, plane geometry of each link plate varies form each other according to the depth of a crotch.

### BRIEF DESCRIPTION OF THE DRAWING

FIG. 1 is a top plan view of a portion of a silent chain according to a first embodiment of the present invention.

FIG. 2 is a front elevational view of a portion of a silent chain of FIG. 1.

FIG. 3 is a front elevational enlarged view of a first guide link.

FIG. 4 is a front elevational enlarged view of a second guide link.

FIG. 5 is a top plan view of a portion of a silent chain according to a second embodiment of the present invention.

FIG. 6 is a front elevational view of a portion of a silent chain of FIG. 5.

FIG. 7 is a front elevational enlarged view of a first link plate that forms a silent chain according to a third embodiment of the present invention.

FIG. 8 is a front elevational enlarged view of a second link plate that forms a silent chain according to a third embodiment of the present invention.

FIG. 9 is a front elevational enlarged view of a standard-type link plate that forms a conventional silent chain.

FIG. 10 is a front elevational enlarged view of a conventional random link.

### DETAILED DESCRIPTION OF THE INVENTION

### FIRST EMBODIMENT

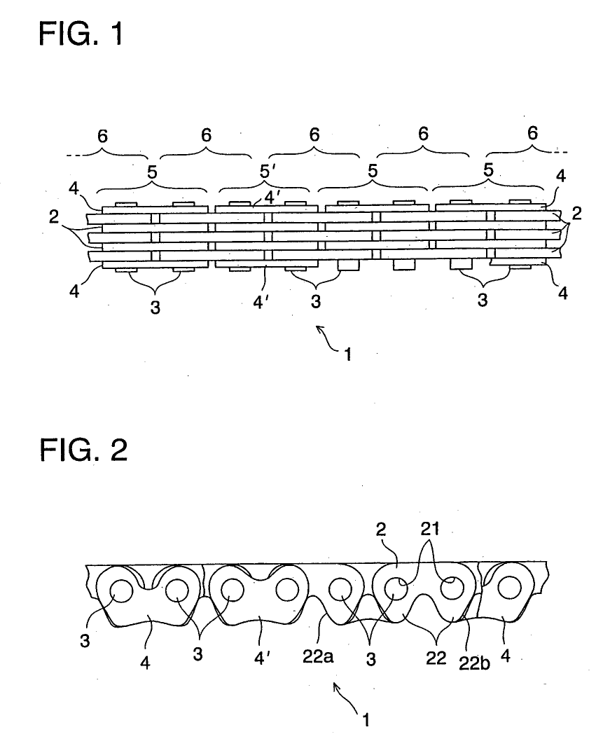

As shown in FIGS. 1 and 2, a silent chain 1 is comprised of a plurality of link plates 2 interlaced in lateral and longitudinal directions and pivotably connected by connecting pins 3. Guide links 4, 4′ are provided on the outermost sides of the link plates 2.

The silent chain 1 is constructed from a plurality of guide rows 5 including a guide link 4, a plurality of guide rows 5′ including a guide link 4′, and a plurality of link rows 6. Each of the guide rows 5 is formed of a guide link 4 and a plurality of link plates 2 that are located at the same longitudinal position as the guide link 4. Each of the guide rows 5′ is formed of a guide link 4′ and a plurality of link plates 2 that are located at the same longitudinal position as the guide link 4′. Each of the link rows 6 is formed of only link plates 2 and interposed between the adjacent guide rows. The guide rows 5 and 5′ are randomly disposed along the length of the chain.

Link plates 2 include a pair of pin apertures 21 and teeth 22. A connecting pin 3 is inserted into each of the pin apertures 21. Each of the teeth 22 are formed of an inside flank 22a and an outside flank 22b that engage with sprocket teeth (not shown).

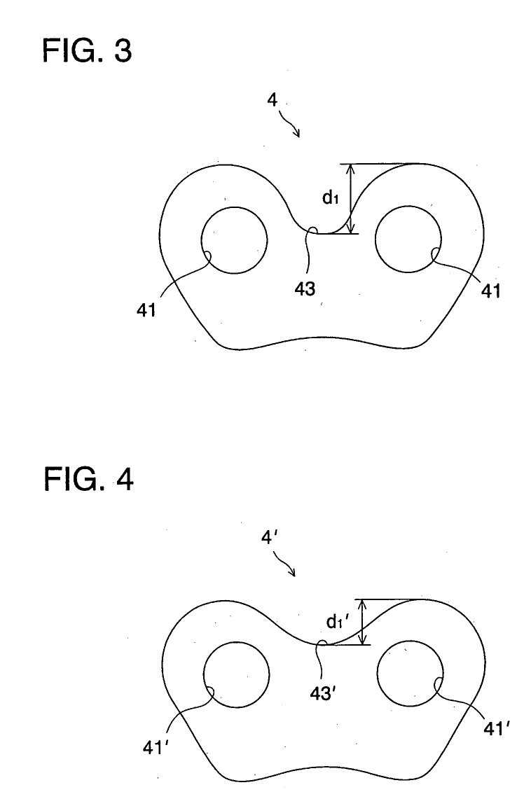

A first guide link 4, shown in FIG. 3, includes a pair of pin apertures 41 and a crotch portion 43. An end of the connecting pin 3 is inserted and fitted into each of the pin apertures 41. The crotch portion 43 preferably includes a circular bottom portion, which extends below the upper edges of the pin apertures 41 and to the vicinity of the centerline of the pin apertures 41. The distance between the bottom portion of the crotch portion 43 and the upper ends of the guide link 4 is referred to as d1.

Similarly, a second guide link 4′, shown in FIG. 4, includes a pair of pin apertures 41′ and a crotch portion 43′. An end of the connecting pin 3 is inserted and fitted into each of the pin apertures 41′. The crotch portion 43′ preferably includes a circular bottom portion, which extends to the vicinity of the upper edges of the pin apertures 41′. The distance between the bottom portion of the crotch portion 43′ and the upper ends of the guide link 4′ is referred to as d1′. As shown in FIGS. 3 and 4, the distance, d1′, is smaller than the distance, d1, i.e. d1′<d1.

In this case, the yield load of the guide link 4 is smaller than that of the guide link 4′ when the tensile load is applied to the chain 1. Therefore, during pre-stress operation, after chain assembly, a pre-stress load is applied to the silent chain 1 in such a way that the tensile load applied is greater than each yield load of guide links 4, 4′ and the plastic elongation of a pitch of the guide link 4 becomes greater than that of the guide link 4′. Thereby, a plastic elongation of a pitch of link plates 2 in guide rows 5 including guide links 4 becomes greater than the plastic elongation of a pitch of link plates 2 in a guide rows 5 including guide links 4′.

As a result, the engagement pitch of link plates 2, i.e. the distance between the outside flanks 22b (and between the inside flanks 22a) along the engaging pitch line, in guide rows 5 including the guide links 4 is made greater than the engagement pitch of a link plates 2 in guide rows 5′ including guide links 4′. Therefore, the guide rows 5, 5′ of different engagement pitchs are located at a random pattern along the length of the chain.

In this case, for example, in the case of a silent chain which initially engages with a sprocket tooth at an inside flank and finally engages with a sprocket tooth at an outside flank, the engaging state of an inside flank 22a of a link plate 2 with a sprocket tooth varies aperiodically at the time of an initial engagement. When the engaging point is transferred from the inside flank 22a to the outside flank 22b and the outside flank 22b seats on the sprocket tooth, the seating state of the outside flank 22b on the sprocket tooth also varies aperiodically. Thereby, noise from the initial engagement to the final engagement, i.e. seating on the sprocket tooth, can be decreased and noise and oscillation performance can be advanced.

### SECOND EMBODIMENT

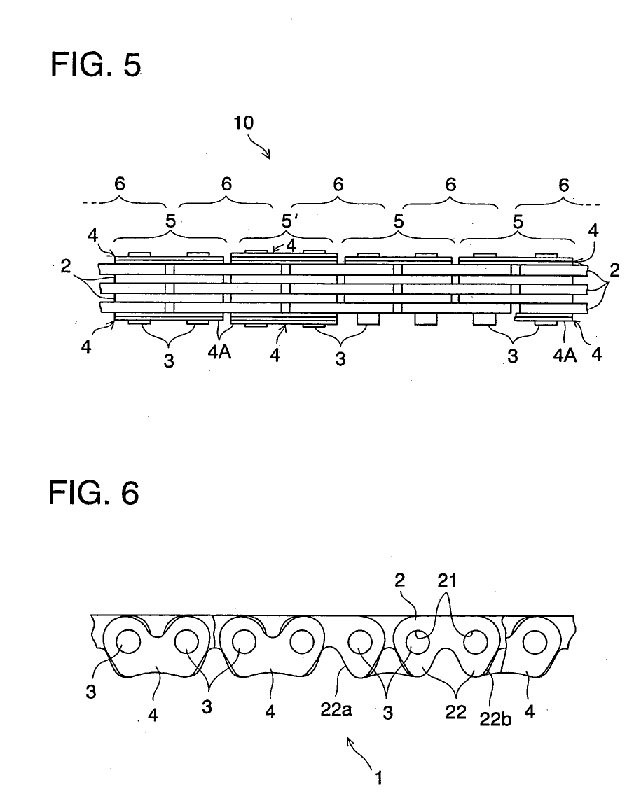

As shown in FIGS. 5 and 6, a silent chain 10 according to the second embodiment of the present invention is constructed from a plurality of guide rows 5, 5′ and a plurality of link rows 6 interposed between the adjacent guide rows. The guide rows 5, 5′ are randomly disposed along the length of a chain. The chain also has link plates 2, which include a pair of pin apertures 21 into which connecting pins 3 are inserted and a pair of teeth each formed of an inside flank 22a and an outside flank 22b.

The guide links 4 of the chain are composed of a plurality of laminated thin plates 4A. In the example shown in FIG. 5, each of the guide links 4 of the guide rows 5 are formed of two laminated thin plates 4A, and each of the guide links 4 of the guide rows 5′ are formed of three laminated thin plates 4B. Therefore, in the case of a plate 4A having thickness of 3 mm, each of the guide links 4 of the guide rows 5 will be 6 mm in thickness, and each of the guide links 4 of the guide rows 5′ will be 9 mm in thickness. In addition, as a plane geometry of each of the plates 4A, for example, a similar configuration to the guide link 4 shown in FIG. 3 of the first embodiment may be employed.

In this case, the yield load of the guide link 4 of the guide rows 5 is lower than the yield load of the guide link 4 of the guide rows 5′. Thereby, during pre-stress operation after chain assembly, a pre-stress load is applied to the silent chain in such a way that the tensile load applied is greater than the yield load of each guide links 4 of the guide rows 5, 5′ and the plastic elongation of a pitch of the guide link 4 in the guide rows 5 is made greater than that of the guide link 4 in the guide rows 5′. Therefore, the plastic pitch elongation of a link plate 2 in the guide rows 5 thus becomes longer than that of a link plate 2 of the guide rows 5′.

As a result, an engagement pitch of a link plate 2 in the guide rows 5 becomes greater than an engagement pitch of a link plate 2 in the guide rows 5′. After pre-stressing, the guide rows 5, 5′ have different engagement pitches and are disposed at a random pattern along the length of the chain.

During operation of the silent chain 1, as with the first embodiment of the present invention, at the time of initial engagement of the sprocket tooth, the engaging state of the inside flank 22a of the link plate 2 with a sprocket tooth varies aperiodically. When the engaging point on the inside flank 22a is transferred to the outside flank 22b and the outside flank 22b seats on the sprocket tooth, the seating state of the outside flank 22b of the link plate 2 on the sprocket tooth also varies aperiodically. Thereby, noise occurred at the time of initial engagement to the seating on the sprocket is lowered and noise and oscillation performance improves.

### THIRD EMBODIMENT

In the above-mentioned first and second embodiments, the yield load of the guide links randomly differ from each other along the length of the chain is shown, but the present invention is not limited to this example. The yield load of a link plate may also be at a random pattern along the length of the chain.

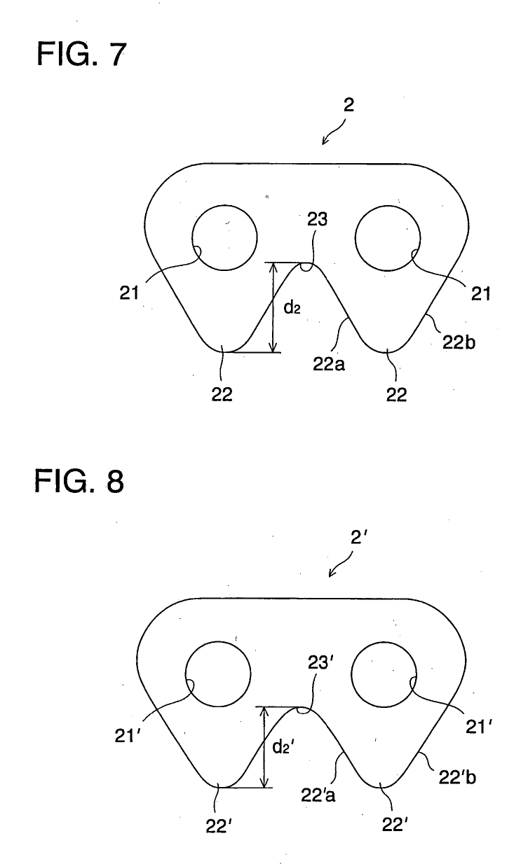

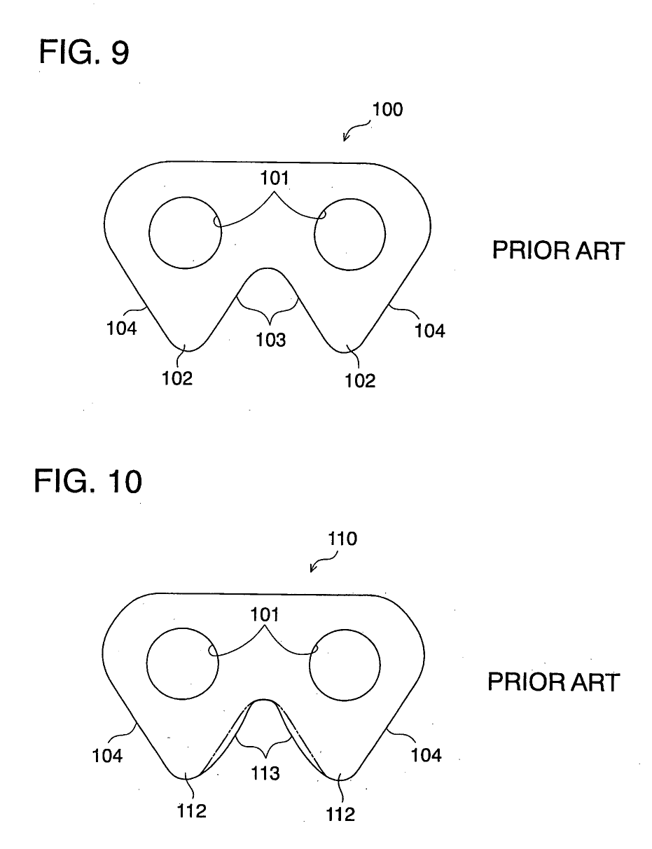

FIGS. 7 and 8 show a first and second link plate forming a silent chain according to a third embodiment of the present invention. In these drawings, like reference numbers indicate identical or functionally similar elements.

As shown in FIG. 7, a first link plate 2 has a similar configuration to the link plate 2 in the first embodiment. An upper end of a crotch portion 23 extends to the vicinity of or beyond the lower edges of the pin apertures 21. The distance between the upper end of the crotch portion 23 and the lower end of the tooth 22 is referred to d2.

As shown in FIG. 8, a second link plate 2′ has a generally similar configuration to the first link plate 2, but the upper end position of a crotch portion 23′ is different from the first link plate 2. That is, in FIG. 8, the distance between the upper end of the crotch portion 23′ and the lower end of the tooth 22′ is referred to d2′, d2′ is smaller than d2, or d2′<d2.

Therefore, in this case, when the tensile load is applied to the silent chain 1, the yield load of the link plate 2 is lower than the yield load of the link plate 2′. Thereby, during pre-stress operation after chain assembly, a pre-stress load is applied to the silent chain in such a way that the tensile load applied is greater than the yield load of each link plate 2, 2′ and the plastic elongation of a pitch of the link plate 2 is made greater than that of the link plate 2′. As a result, the engagement pitch of link rows having the link plates 2, becomes greater than an engagement pitch of link rows having the link plates 2′. The link rows having different engagement pitches are disposed at a random pattern along the length of the chain.

During operation of the silent chain 1, at the time of initial engagement of the sprocket tooth, the engaging state of the inside flank of the link plate with a sprocket tooth varies aperiodically. When the engaging point on the inside flank moves to the outside flank and the outside flank seats on the sprocket tooth, the seating state of the outside flank on the sprocket tooth also varies aperiodically. Thereby, noise occurred at the time of initial engagement to the seating on the sprocket is lowered and noise and oscillation performance improves.

### OTHER EMBODIMENTS

In the above-mentioned first to third embodiments, two kinds of guide links or link plates of different yield load were used and the yield loads of only the guide links or only the link plates were altered in the chain length direction. The present invention can also be applicable when more than three kinds of guide links or link plates are used and when yield loads of both the guide links and the link plates are altered in the chain length direction.

A guide link that is applicable to the present invention may be not only a combination of a guide link of FIG. 3 with a guide link of FIG. 4 in the first embodiment but also a combination of a guide link where a bottom end of a crotch portion extends beyond the pin aperture centerline with a guide link of FIG. 3 similar to the first embodiment. Plus, a guide link without a crotch portion may be combined. Furthermore, a guide link with a central through hole formed therein may also be employed.

In addition to changing a plane configuration in the above-mentioned manner or changing a thickness of a guide link as shown in the second embodiment, a method to alter the yield load of the guide link may include changing a hardness of the guide link by changing materials or heat treatments.

Plus, some of the differences in thickness, hardness and plane configuration may be combined. Thereby, for example, the yield load of the guide link can be made one-half of the yield load of the link plate.

Furthermore, a method to alter the yield load of the link plate may include changing a plane configuration as shown in the third embodiment, or changing a thickness, material or hardness. As an example of change in thickness, as with a guide link in the second embodiment, a plurality of laminated thin plates may be utilized.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A silent chain comprising:
a plurality of interlaced link plates, pivotably connected by connecting pins, each having a pair of teeth; and
a plurality of guide links disposed along the plurality of link plates, comprising a random plurality of first guide links and a plurality of second guide links, wherein the first guide links have a yield load and the second guide links have a yield load different from the yield load of the first guide links.

2. The silent chain of claim 1, wherein the plurality of interlaced link plates are comprised of a mixture of first link plates and second link plates.

3. The silent chain of claim 2, wherein the first link plates have a first yield load and the second link plate have a second yield load, different from the first yield load.

4. The silent chain of claim 2, wherein the mixture of the first link plates and the second link plates are randomly placed along the chain.

5. The silent chain of claim 2, wherein the first link plates have a different characteristic than the second link plates selected from the group consisting of:
a) thickness;
b) hardness;
c) material; and
d) plane geometry.

6. The silent chain of claim 2, wherein the mixture of the first link plates and the second link plates are formed of a plurality of laminated plates.

7. The silent chain of claim 3, wherein the yield load of the first guide links and the yield load of the second guide links are lower than the first yield load of the first link plates and the second yield load of the second link plates.

8. The silent chain of claim 1, wherein the first guide links have a different characteristic than the second guide links selected from the group consisting of:
a) thickness;
b) hardness;
c) material; and
d) plane geometry.

9. The silent chain of claim 1, wherein the first guide links and the second guide links are formed of a plurality of laminated plates.

10. A method of producing a silent chain comprising the steps of:
a) interlacing a plurality of link plates in a link thickness and length direction to form a plurality of link rows along the length of the chain;
b) preparing first guide links with a yield load and second guide links with a yield load, wherein the yield load of the first guide links are different than the yield load of the second guide links;
c) placing the first guide links and the second guide links in guide link rows in a random pattern along the length of the chain;
d) connecting the link plates, first guide links, and second guide links together with connecting pins; and
e) applying a pre-stress load to the chain after the chain is assembled, such that a load greater than the yield load of the first guide links and the yield load of the second guide links acts on the first guide links and the second guide links and an engagement pitch of a first guide row and an engagement pitch of the second guide row after pre-stressing are located at a random pattern along the chain length direction.

11. A method of producing a silent chain comprising:
a) interlacing a plurality of first link plates each having a first yield load and a plurality of second link plates each having a second yield load different from the first yield load in a link thickness and link length direction to form a plurality of first link rows composed of the first link plates and a plurality of second link rows composed of the second link plates at a random pattern along the length of the chain;
b) connecting the first link rows and the second link rows by connecting pins; and
c) applying a pre-stress load to the chain after assembly of the chain, wherein a load greater than the first yield load and the second yield load act on the first link plate and the second link plate and an engagement pitch of the first link rows and an engagement pitch of the second link rows after pre-stressing are located at a random pattern along the chain length direction.

12. A silent chain comprising:
a plurality of interlaced link plates comprising a plurality of first link plates and second link plates, each having a pair of pin apertures, a pair of teeth, and a crotch portion between the teeth, the plurality of interlaced link plates being pivotably connected by connecting pins, wherein the first link plates have a yield load and the second link plates have a yield load, different from the yield load of the first link plates; and
a plurality of guide links randomly disposed along the plurality of link plates.

13. The silent chain of claim 12, wherein the upper end of the crotch portion of the first link plates extends to or beyond a lower edge of the pin apertures and the second link plates have a crotch portion which is smaller than the crotch portion of the first link plates.

14. The silent chain of claim 12, wherein the plurality of guide links are comprised of first guide links and second guide links.

15. The silent chain of claim 12, wherein the first guide links have a yield load and the second guide links have a yield load different than the first guide links.

16. The silent chain of claim 12, wherein the first guide links and the second guide links have crotch portions, the crotch portion of the first guide links extend beyond a pin aperture centerline of the link.

17. The silent chain of claim 16, wherein the crotch portion of the second guide links are smaller than the crotch portion of the first guide links
